(19) United States
(12) Patent Application Publication
(10) Pub. No.: US 2010/0168934 A1
(43) Pub. Date: Jul. 1, 2010

(54) Robotic Golf Caddy

(75) Inventors: David Charles Ball, Victoria (AU); Hubert Novak, Victoria (AU); Michael George Hamilton, Victoria (AU)

Correspondence Address: SHOEMAKER AND MATTARE, LTD, 10 POST OFFICE ROAD - SUITE 100, SILVER SPRING, MD, 20910, US

(73) Assignee: YOUR SHADOW TECHNOLOGIES PTY LTD, Dandenong South, Victoria (AU)

(21) Appl. No.: 12/301,116

(22) PCT Filed: May 17, 2007
(86) PCT No.: PCT/AU2007/000670

§ 371 Date: Jan. 6, 2009

(30) Foreign Application Priority Data
May 17, 2006 (AU) 2006902624

(51) Int. Cl. G06F 17/00; B62D 1/24

(52) U.S. Cl. 701/2; 180/167

(57) ABSTRACT

A self propelled robotic vehicle that faithfully follows a portable receiver at a defined distance can sense an impending collision with a solid object in its path and stops prior to collision. The vehicle observes objects that are parallel to its course and if within a distance of <200 mm inhibits the steering such that the vehicle is not able to collide even if the receiver instructs a convergence path. The vehicle stops and ceases moving if it contacts any solid object. The vehicle can sense unsafe gradients and ceases following if acceptable operating limits are exceeded. The vehicle can be used as a golf caddy, transport vehicle or cart, robotic pallet and robotic assistant.

### FIELD OF INVENTION

The present invention relates to robotic vehicles and responsive self-propelled equipment. The present invention may be used in different agricultural and industrial environments and has a variety of personal service applications. The present invention has particular application for use as a robotic golf caddy. A robotic golf caddy is described in the specification by way of example only and the invention is not limited to this example.

### BACKGROUND OF THE INVENTION

Different robotic golf caddies have been developed using one or more guidance methods and a drive assembly to automatically follow a golf player around the golf course. The guidance methods include ultrasonic signals (U.S. Pat. No. 5,611,406, U.S. Pat. No. 6,142,251), GPS navigation (U.S. Pat. No. 5,944,132, U.S. Pat. No. 5,711,388) and guide tapes (U.S. Pat. No. 5,944,132) for positioning the caddy. The robotic golf caddies employ these guidance methods to determine their position relative to their environment and the player and use the position information to move in accordance with set navigational rules. Each of the current guidance methods has disadvantages and limitations.

The GPS guidance method of U.S. Pat. No. 5,711,388 uses digitally stored maps and navigation rules combined with positional information using differential GPS techniques to determine movement of the robotic caddy. The robotic caddy described in U.S. Pat. No. 5,963,150 uses a satellite positioning system to receive high frequency signals from the caddy and the user in calculating positional information. Satellite positioning methods however suffer from the disadvantages that they require both the caddy and player to continually transmit locating signals and a sufficient number of satellites to maintain accurate positional information. Furthermore the use of GPS positioning has an error range of several meters or more which is beyond the acceptable limits for use on a golf course particularly where there are objects on the course to be avoided. Using GPS navigation as the sole guidance method has limitations.

A further problem identified when there is a plurality of robotic golf caddies on a golf course is caddy identification and ensuring the caddy follows or responds to the correct player.

### OBJECT OF THE INVENTION

It is an object of the present invention to provide an alternative robotic vehicle which overcomes at least in part one or more of the above mentioned disadvantages.

### SUMMARY OF THE INVENTION

In one aspect the present invention broadly resides in a self-propelled robotic vehicle responsive to a radio frequency signal from a transmitter means including
a vehicle frame means;
at least two spaced apart receiver means adapted to receive the signal from the transmitter means;
a processor operatively associated with the receiver means, said processor is programmed to process input from the at least two spaced apart receiver means to locate the position of the transmitter means and produce an electrical signal for the vehicle to move relative to the transmitter means in accordance with the processor programming; and
drive means supported on the vehicle frame means and adapted to receive and act on the electrical signal sent from the processor to move the vehicle in accordance with the processor programming.

In a further aspect the present invention broadly resides in a system for a self-propelled robotic vehicle including
transmitter means able to transmit a radio frequency signal;
a self-propelled vehicle including a vehicle frame means; at least two spaced apart receiver means adapted to receive the signal from the transmitter means; a processor operatively associated with the receiver means, said processor is programmed to process input from the at least two spaced apart receivers to locate the position of the transmitter means and produce an electrical signal for the vehicle to move relative to the transmitter means in accordance with the processor programming; and drive means supported on the vehicle frame means and adapted to receive and act on the electrical signal sent from the processor to move the vehicle in accordance with the processor programming.

The receiver means preferably includes two spaced apart antennas with each operatively linked to a receiver. The receivers are preferably Super Heterodyne type or Near Zero IF type. The antennas are preferably spaced apart at a distance from each other. More preferably, the antennas are 25 cm or more spaced apart from each other.

The two spaced apart antennas are preferably operatively connected to enable the processor to process the signal inputs to determine the location of the transmitter. The receiving antennas are preferably arranged with one antenna peak tuned and the other is dip tuned so that they are 90 degrees out of phase. The processor preferably can combine the two signals for a summed RSSI reading and measure a phase shift to determine the position of the transmitter means.

Preferably the antennas have resonator coils that enable them to be dynamically tuned. With tuning the antenna, the predefined frequency is preferably set by varying the capacitance of the coil by the voltage to peak tune the antenna to the defined frequency.

The transmitter means is preferably a transponder that transmits a signal but not receive a signal. The transmitter means is preferably portable. Alternately transmitter means may be a transponder which is activated on receiving a radio frequency signal from the vehicle and transmits a location signal back to the vehicle.

Preferably the transponder is wearable and has a frequency between 200 Khz to 8 Ghertz. More preferably the transponder has a frequency between 300 Khz and 500 Khz.

The transponder preferably has a plurality of capacitors so that the transponder antenna can be dynamically tuned and shifted in 5 KHz increments to form 5 KHz channels. The signal is carrier modulated by frequency shift keying (FSK) where the keying rate is 300 Htz and the frequency shift is +/−1 Khz either side of the carrier forming a 300 Htz tone.

The radio frequency signal is preferably a suitable frequency to enable identification of the vehicle and activation of the vehicle to move in accordance with the processor programming. The radio frequency signals are preferably arranged in channels. The signal processing is preferably able to identify separate transmitter channels and negate any adjacent channel interference.

Within the defined range of the radio frequency signals, the number of vehicles responding to transponder specific signals within an area may be increased by one or more methods including random transmission cycle for the transponders where the transmissions are coded so that they can be decoded and used by the corresponding vehicle. Alternately the frequency from the transponder may be modulated at a FSK keying rate of 500 Htz with +/−1 Khz frequency shift so that the receivers can identify their corresponding transponder. Furthermore the transponder preferably has a random number generator which is used to trigger transmit time so that transmissions are not synchronized to avoid the situation where multiple simultaneous transmissions are received by a receiver.

The drive means preferably includes a motor with a reduction gear box and a plurality of wheels operatively connected to the motor. The plurality of wheels preferably includes at least one wheel driven by the motor. In one preferred form, the vehicle has three wheels with two rear wheels driven by the motor. Preferably there is a motor associated with each of the rear wheels. Alternatively, there is a single motor having a differential gearing to drive both wheels. In a preferred embodiment the front wheel can steer the vehicle in accordance with the processor programming.

The vehicle frame means preferably includes a frame body and chassis.

The vehicle may be any suitable vehicle including a golf caddy, transport vehicle or cart, robotic pallet and robotic assistant.

The vehicle preferably has a manual operation system where it does not respond to radio frequency signals and the gears and automatic braking system are preferably disengaged. In the manual mode, the vehicle can be pushed or pulled by a player or alternatively be towed by another vehicle.

The vehicle preferably has a collision avoidance system that enables the vehicle to avoid or stop before it contacts an object. The vehicle preferably has a collision avoidance system that has a plurality of infrared ranging transceivers spaced about the vehicle. The collision avoidance system preferably includes infrared charge coupled device (CCD) range sensors located about the vehicle and capable of detecting objects between 0.01 and 5 meters and more preferably up to 1.6 meters from the sensor. The collision avoidance system preferably has guard bands that provide an outer boundary and an inner boundary about the vehicle. Preferably an alarm and or response in accordance with the processor programming is actuated when an object enters the outer or inner boundaries. The outer boundary is preferably set between 1 and 2 meters and more preferably 1.2 meters from the vehicle. The inner boundary is preferably set between 0.01 and 1 meters and more preferably 0.3 meters for the front of the vehicle and 0.08 meters for the sides of the vehicle. Preferably there are rules forming part of the processor programming that direct the operation of the vehicle when an object is detected by the infrared CCD sensors.

The vehicle may also include a satellite navigation system to assist in controlling the movement of the vehicle in a defined area.

The system preferably has the capability of recording the operational time of the vehicle. Preferably the vehicle can alert a remote monitoring system whether the operational time is approaching its allocated time. Preferably all usage of the vehicle is recorded.

The vehicle preferably has an override system where the electrical current powering the wheels increases up to a threshold level to keep the wheels turning. When the threshold level is reached or exceeded the current to the motor is preferably stopped. The override system is preferably activated when the vehicle moves up a very steep slope, when there is too much weight on the vehicle and when one or more wheels lose traction.

In another embodiment the vehicle may have a weight sensor that detects whether the weight of the vehicle is over a predetermined limit and if so the vehicle stops.

In another embodiment the vehicle may have a lateral sensor to detect sideways tipping movement of the vehicle.

In another embodiment the vehicle may have a gradient sensor that is able to sense the incline of a gradient and if over a predetermined limit, the processor will prevent the vehicle from continuing movement in the inclined direction.

### BRIEF DESCRIPTION OF THE DRAWINGS

In order that the present invention can be more readily understood and put into practical effect, reference will now be made to the accompanying drawings wherein:

FIG. 1 is a photograph of a robotic golf caddy of the preferred embodiment of the invention;

FIG. 2 is a diagrammatic view of the operational components of the robotic golf caddy;

FIG. 3 is a diagram of decisions with respect to the collision avoidance system;

FIG. 4 is another diagram of decisions with respect to the collision avoidance system;

FIG. 5 is another diagram of decisions with respect to the collision avoidance system;

FIG. 6 is another diagram of decisions with respect to the collision avoidance system;

FIG. 7 is another diagram of decisions with respect to the collision avoidance system; and

FIG. 8 is another diagram of decisions with respect to the collision avoidance system.

### DETAILED DESCRIPTION OF THE PREFERRED EMBODIMENT

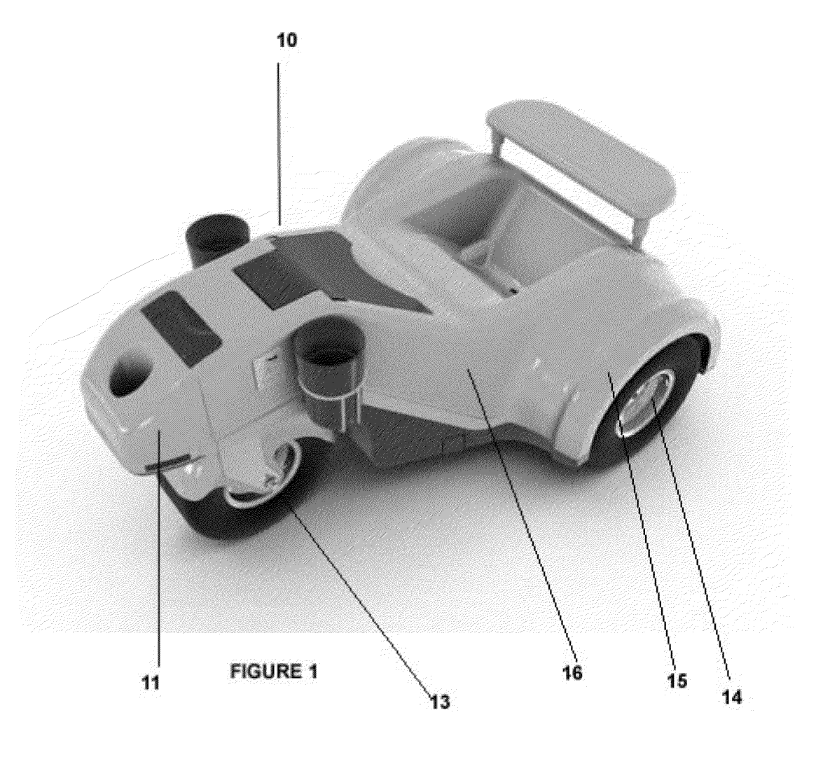

The detailed description of the preferred embodiment refers to a robotic golf caddy. With reference to FIG. 1, there is shown a robotic three wheeled vehicle being a golf caddy 10 that operates in a variety of modes controlled by a remote transceiver unit (RTU). The remote transceiver unit is worn (such as on a belt) or carried by the player.

The robotic golf caddy 10 can transport a full set golf bag and all the usual golfing accessories whilst following the player with the respective transponder over the primary areas of a golf course (that is fairways and green to tee walkways).

The caddy is electronically controlled to be self managing with regard to the follow function and proceed-no-further function when the player enters an inappropriate area for the caddy.

The caddy electronic system has two spaced apart antennas 11, directions finding system, distance determination system, vehicle host controller, collision avoidance system, drive control system, battery and power supply, cable connection and external battery charger.

The caddy mechanical system has a vehicle frame 12, self steering front wheel assembly 13, rear wheel assembly 14, rear wheel gear box assemblies and rear wheel drive motors 15, vehicle body 16 and battery housing.

The remote transceiver unit has a housing and belt clip, radio transceiver, lithium ion battery, battery charger and antenna system.

The remote transceiver unit mass charging unit has a housing for plugging in eight RTU batteries, AC mains power supply and DC charging unit.

The key functionality of the RTU is that it provides an RF transmitting location source for the Caddy receiver electronics and location system. As such its key function is to transmit an identifiable beacon signal that has a precise and consistent frequency that is uniquely coded as well, so that it is identifiable only by its respective Caddy. The unit housing is purpose designed to allow for best form fit and use and will have the following controls integrated onto a single printed circuit board housed internally : power switch (including range switch); follow me mode and On/off switch.

The power switch has a latching switch that requires positive and determined action to change state. The power switch will cause the internal electronics to power on. The power switch is integral with range switch and causes the RTU electronics to adjust the power output of the RF transmitter. The follow me mode switch will cause the internal electronics to activate the RF transmission of beacon.

The power switch has 4 positions where the power is adjusted in linear range increments from position to position in order to achieve an operating range of 1.5 meters to 4 meters. The device has one Led mounted that are readily visible to the wearer and that indicate when lit: power on; follow me mode on; and low battery. The RTU has replaceable 2 AA size alkaline or Nickel metal hydride battery with a capacity of 2800 ma hours. It will have an external charger circuit capable of recharging the 2800 mah NiMh battery from discharge to full charge within 6 hours maximum.

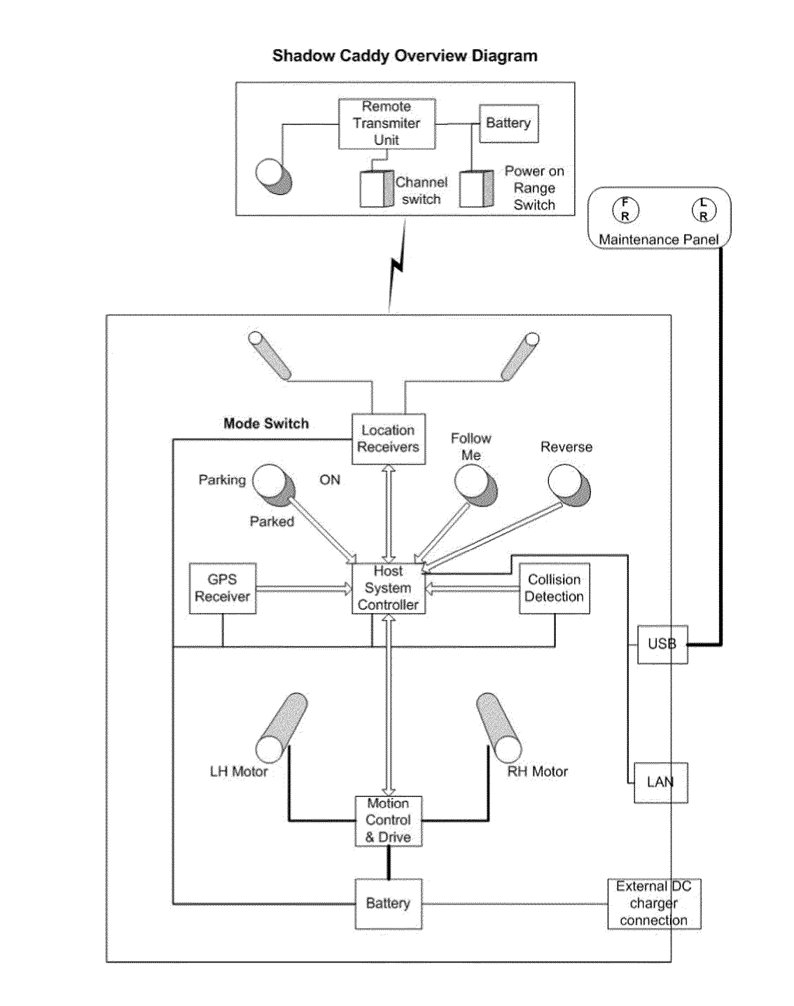

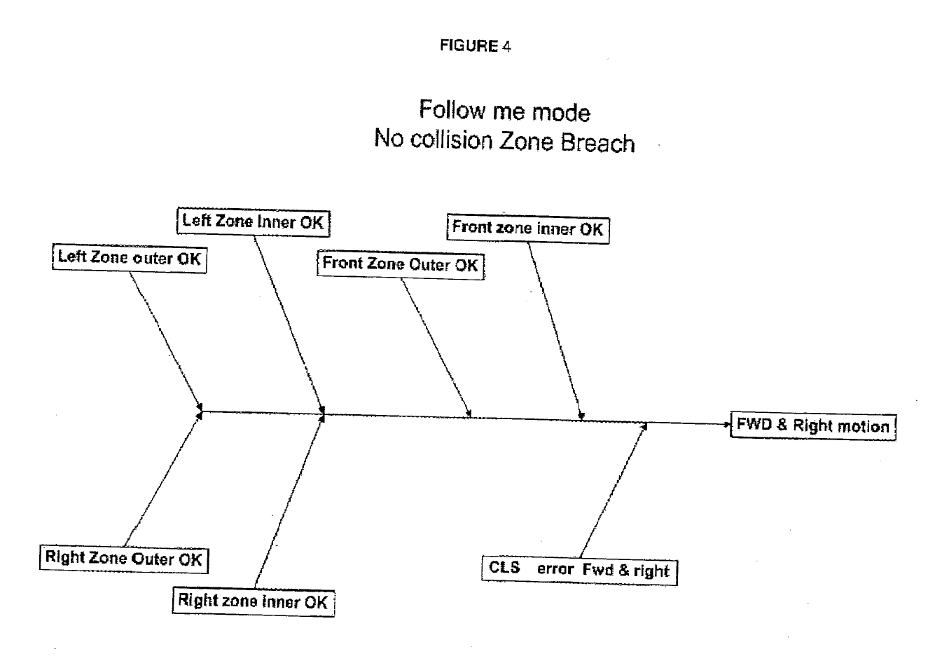

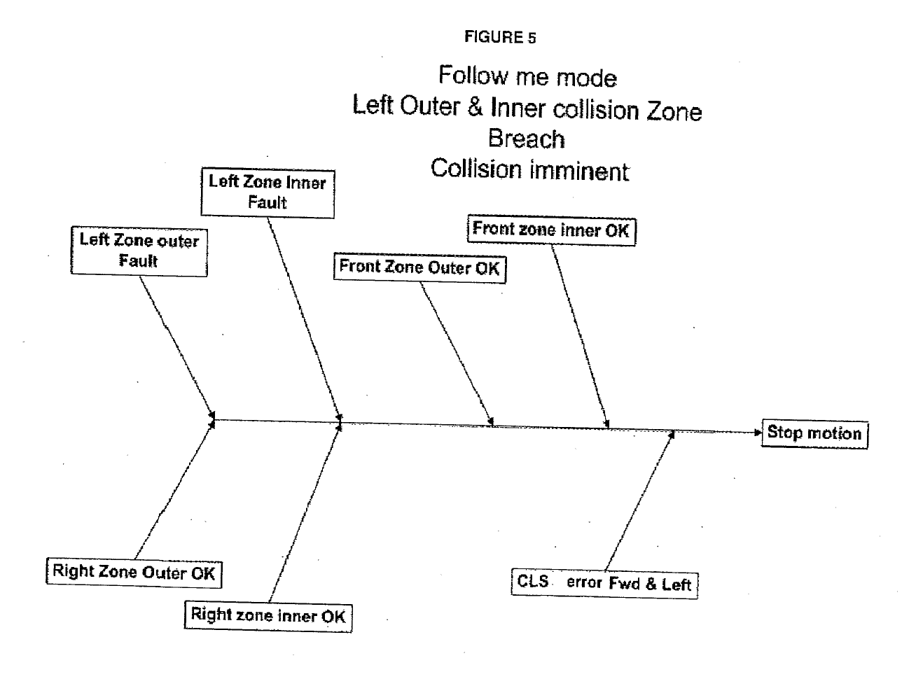

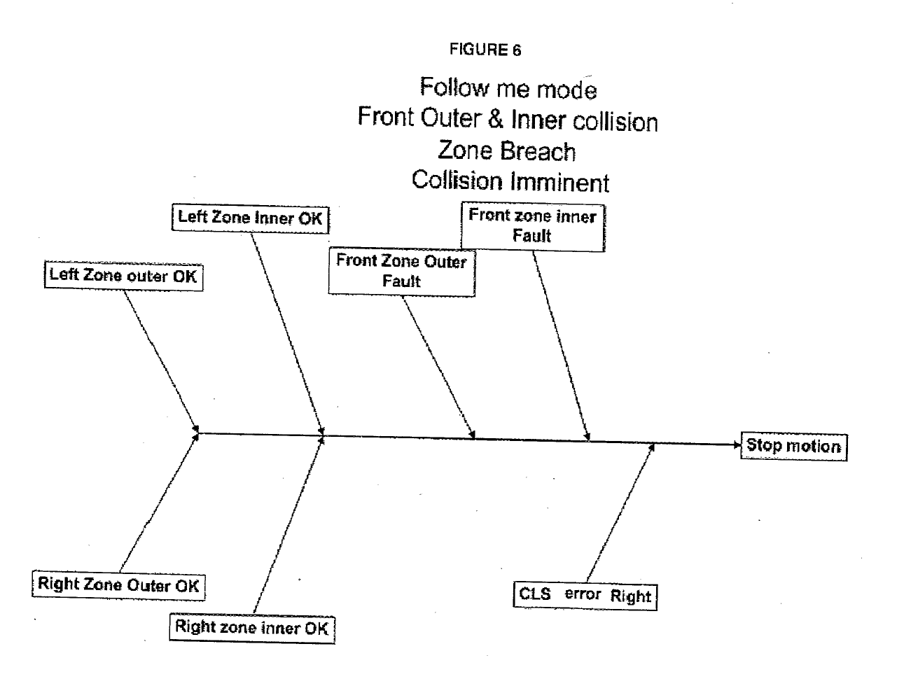

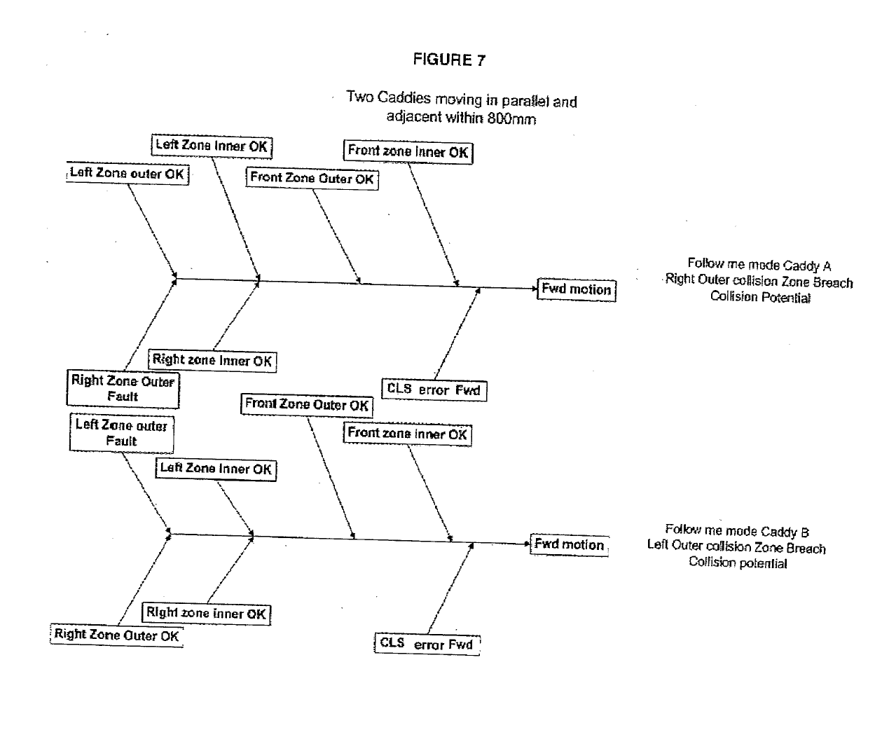

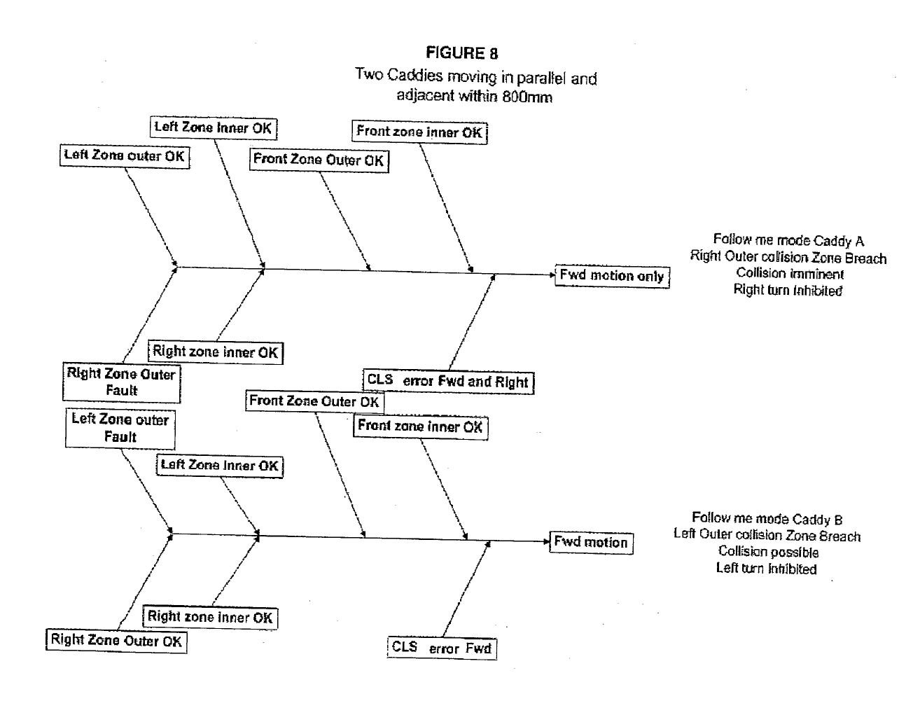

The caddy and RTU will now be further described with reference to FIGS. 2 to 8.

### Operational Description of the Caddy

The Caddy has several operating modes in terms of movement which are activated by a key switch. The positions of the key switch include on, off and parking.

While in any power on mode, the host system will record operating hours of the caddy.

### Follow Me Mode

There is a separate follow me switch which is either on or off. This mode of operation is the primary mode for use of the vehicle. The golf caddy is controlled by the respective RTU as both entities are keyed with the same radio frequency. When the RTU moves away from the caddy, the electronics system determines the direction and rate at which the RTU is moving and will control the drive mechanism to the rear wheel set and their respective motor drives such that the vehicle will follow the RTU at a rate and direction equivalent to the RTU's movement. The control system will ensure that a predetermined distance will always be maintained between the caddy and the RTU when the RTU is activated.

This mode of operation will work in conjunction with the collision avoidance system (and where applicable satellite navigation out of bounds system). These systems will provide an indication as to whether the follow me mode is enabled or disabled. For example, if the player with the RTU moves to a position where the caddy in follow me mode would collide with an object or move in an out of bounds with respect to the processor programming, then follow me mode would be disabled and movement stopped.

In order to re-enable follow me mode, the player must move to a position that the caddy can proceed to without breaching set navigational rules and processor programming.

Follow me mode is disabled by turning the switch to the off position.

### Parking Mode

Parking mode is a mode of operation that allows golf course personnel to manipulate the vehicle without the use of the respective RTU. The parking mode is enabled by a security key and will cause the on-board electronic systems to put the drive mechanism into free wheel mode such that the unit can be manually manoeuvered to a required parking position.

### Parked Mode

Parked mode occurs when off is selected on the key switch. Parked mode enables golf course personnel to lock the vehicle in a parked position so that the driving wheels are locked and the vehicle is disabled from movement.

### Battery Charge Mode

The battery charge mode occurs in the off position of the key switch and allows recharging of the primary battery through a connection to an external power source.

In the preferred embodiment the vehicle automatically enters parked mode when a charging cable is connected and will remain in this mode until the external connection is disconnected. The vehicle will automatically enter parked mode when the charging cable is connected irrespective of whether another mode of operation has been selected.

### Reverse Mode

The reverse mode is a mode of operation that enabled the caddy to reverse with neutral steering. Reverse mode is activated with a switch on the caddy.

### Operational Description of the RTU

The RTU is a transceiver unit that when powered and activated will transmit a unique signal that the corresponding caddy recognizes and locks on to. The operating range of the RTU depends on the frequency that is transmitted by the caddy. The operating distance of the caddy from the RTU will also depend on how the RTU is worn or carried by the player. The maximum distance for operation of the caddy from the RTU is four meters and the minimum distance is 1 meter. When a player with the RTU walks towards and then past the respective caddy the caddy will rotate and follow the player within the predetermined distance range. The follow me distance is adjustable on the RTU.

The RTU has the following functions: power on/off; and follow me on/off.

The RTU is a portable transceiver system that when activated transmits the requisite signals to allow the caddy transceiver and location system to determine the location of the RTU and hence player.

The RTU is powered by an internal battery which is replaceable and is rechargeable from a separate charger unit.

### Operation Description of the Caddy

The caddy has the following function selections: power on/off/parking key switch); follow me mode switch on/off; reverse mode switch on/off.

Caddy Antenna system and Receiver (CAR)

The caddy receiver includes a dual antenna system and dual recievers. The receiver provides analogue data to the processor (location system) for processing the current location of the RTU.

The Caddy antenna system comprises an antenna array that functions as an in phase switched dual antenna array. The dual antenna array provides two separate antenna feeds to the two separate receivers. The quadrature outputs of the two receivers are compared with a phase comparator circuit to determine phase change and hence azimuth of the received RTU signal. The CLS system is calibrated for mid position phase comparator signal and provides variation left or right to the main processor. When the antenna system is pointing directly at the received signal source there shall be no phase difference and hence no tone or Null state.

The receiver may be a conventional Super Heterodyne type or may be a Near Zero IF type. The receiver sensitivity allows it to differentiate an incoming wanted receive signal on its selected channel of operation down to a level of −90 Dbm for a signal transmitted by the RTU at a distance of 4 meters from the RTU. The receiver provides an accurate RSSI analogue level proportional to the level of the received signal with such signal level being the aggregate of two measurements made from both antennae within a time frame of 20 μseconds.

The RTU transmits a narrow band signal on a given channel. The receiving antennas are set up with one antenna peak tuned while the other is dip tuned. The antennas operate 90 degrees out of phase. As a result there is a diminution in received signal strength from one antenna. The feeder coil on one antenna is cross coupled to the other antenna and vice versa so they are balanced.

The antenna signals are fed to separate receivers. The signals are combined for a summed RSSI reading and output from each receiver is also feed into a phase comparator circuit which compares the phase of the two signals. The result of the comparison is a range of out-of-phase measurements dependent on the RTU movement. An analogue signal dependent on the phase shift is then generated. This signal is sent to the processor to calculate the angle of the RTU relative to the centre between the antennas.

Caddy Location system (CLS)

The location system accepts analogue data from the caddy receiver which it processes on a continuous basis so as to be able to provide angular and distance location data in digital form to the system host controller. The signals are preprocessed (PLD processing) to provide the system host controller with an operational state. If the preprocessed signals indicate that the caddy is outside the desired distance, then the processor receives a default error signal thereby initiating a response by the caddy to reposition itself to its desired distance.

The location system has a separate logical function that will take analogue data from the CAR system in terms of tone/phase and RSSI and convert it to positional data and send it on a continuous change basis to the caddy host control system (CHC) via a three wire serial bus. In the event that the analogue data is not changing, that is the RTU is not turned on or out of range then the CLS will send an RTU Off or out of range heartbeat to the CHC. Should the RSSI analogue data level rise above a set maximum for 1 meter then CLS will indicate to the CHC that a golfer with RTU enabled is present and has approached the Caddy within the minimum operating distance of 1.5 meters from antennas.

### Collision Detection System

The requirement of the collision system is for the caddy to turn off before contact with a solid object.

Collision avoidance system

The collision avoidance system determines if any object of sufficient mass is in the path of the vehicle within a specified minimum distance and informs the host controller in the event that this occurs. The host controller will apply braking to the motion system such that the caddy will cease motion prior to a collision and that an indication is given to the player as to why the unit has stopped.

The key function of the Collision avoidance system is to ascertain when the vehicle is in motion or motion is intended if any object is in the intended path of travel at a distance of 1 meter or less. The detection process is performed by use of infrared (IR) CCD (charge coupled device) sensors which transmit a narrow beam width of IR wavelength light with a CCD sensor that looks at any reflections of its own signal being returned. From the angle at which it is returned the sensor is able to determine the distance from the sensor of the reflecting object. The sensor provides an output that is an analogue voltage representation of measured distance.

Ten sensors are positioned around the caddy and can detect anything out to 1.6 meters from the sensor. There is an outer band around the forward motion section of the caddy of 1.2 meters and an inner boundary of 0.3 meters. The side sensors are set with an inner boundary of 0.08 meters.

The configuration of the IR CCD array can detect anything in field of view to the left, forward or right. Forward motion is conditioned on what the array has detected and influenced by the set rules defined in the programming. For example we can negate the caddy from turning into an object even if the object is between the RTU and the caddy. In the situation where the golfer walks past an object and turns sharply left, the caddy will continue forward until the object is cleared before allowing the left hand turn.

The devices will not arbitrate function but merely report to the Caddy Host Control system if any object exists within a determined perimeter of each of the infrared CDD field of view.

The control system that commands motion as a response to Follow me mode constantly takes into consideration the state of all zone inputs. The follow me function is an enabled control loop that is responding to changes of data provided from the Location system which is of itself another constantly operating loop that is calculating the location of its designated RTU and is setting an error in both range and azimuth relative to a zero position. The Zero position being the desired distance (2-4 Meters) and bearing (0 degrees). These control loops are operating at a rate exceeding 500 iterations per second.

The Follow me control loop issues commands to the Motion controller such that the vehicle will move so that the Location system returns a Zero position for range and bearing.

The collision avoidance data is fed to the Follow me control loop on a continuing basis so that all decisions to issue motion commands take the zone status into effect. For example, if the Front outer zone is breached but the front inner zone is not and both left and right zones are clear then the Caddy is allowed to rotate right or left but not proceed forward. If the location system indicates a range error requiring forward movement then the Caddy will not move and a collision inhibit state is in force. If the location system indicates an azimuth error but not a range error then the caddy will swing right or left as may be required. In the event this action results in the front outer zone breach being cleared, then the forward motion inhibit will be removed. In the event that any zone inner band is breached, then the vehicle stops and manual intervention will be required.

When negotiating a rise, the Caddy Motion Control in conjunction with the Location system is constantly attempting to keep the Caddy located at 2 to 4 meters from the golfer with its respective RTU and on a bearing of zero degrees. This is achieved by operating in closed loop mode once the RTU has been acquired by the Radio Location system.

Any movement of the RTU relative to the Caddy will cause a set of error signals to be output from the location system which will be dynamically responded to by the Host Controller in commanding the motion control system to move such that the location system error is reduced to zero.

In the event of a caddy following a golfer up a rise then the same applies and the host will increase the motion commands consistent with tracking the RTU at its zero range and azimuth position. Equally when traversing down a rise then the Host will issue motion command consistent with the reduced level of power required such that the Caddy maintains its required distance. This process is in a loop control whereby the location of the RTU and the vehicle position process is occurring at up to 500 times per second.

With regard to the Caddy negotiating trees and other obstacles, the Caddy will not drive into a tree should a golfer attempt to achieve same. For example if a golfer walks to a tree then goes immediately around it the caddy will continue only if its path forward is clear and no inner zone faults are being detected. In this event it is unlikely and the Caddy will stop. If however the golfer walks past a tree to a distance that is greater than half the width of the Caddy plus 300 mm and then turns behind the tree the Caddy will continue going forward until it has clear guard zone status and then turn. The same applies with respect to any object whether it is a tree or a person.

Where there is another golfer or caddy, the two golfers each have their own RTU and Caddy and may walk together in parallel along a fairway. In this instance, the golfers may be closer together than the Collision Avoidance System will allow. The Caddy behavior will be such that the left hand unit will have its right outer guard zone limit breached and the right hand unit will have its left hand outer guard zone limit breached. This will result in the left hand unit being inhibited from turning right and the right hand unit being inhibited from turning left. Should one golfer (say the right hand one) walk left across the path of the other then his caddy will not follow him as it is inhibited. This will result in the Caddy loosing contact with its respective RTU and it will stop. The other golfer will have continued on his way and will have effectively passed the other. The golfer who has now lost touch with his caddy and will have to walk back to it to regain contact. However a collision has been avoided.

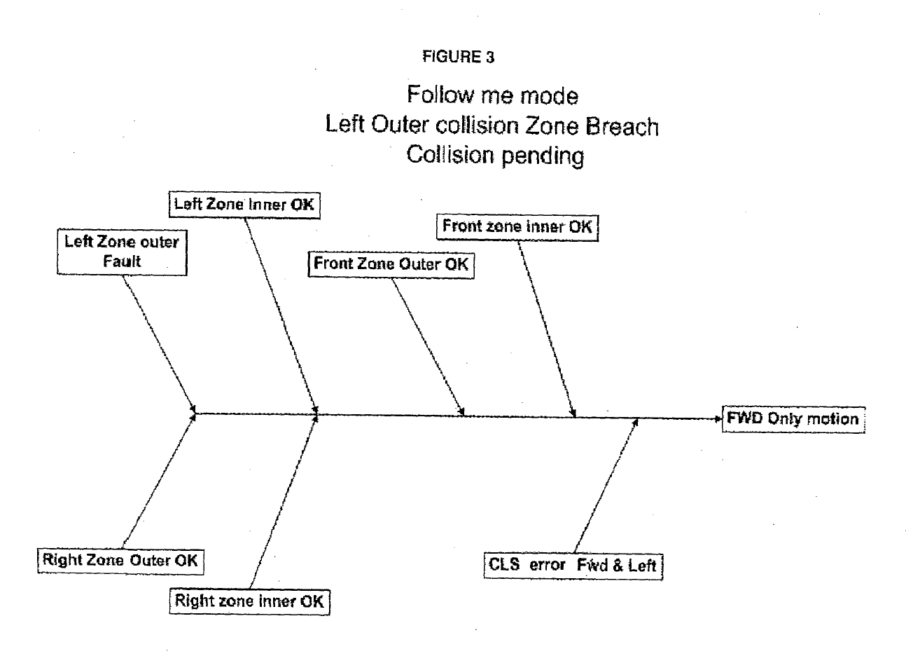

FIGS. 3 to 8 illustrate the decision making process of the collision avoidance system.

### Keep Out System

The Keep out system is a satellite navigation receiver that is continuously updating its position data and it provides such data to the host controller. The host controller has a table of allowable co-ordinate data within which the caddy is allowed to operate and if the co-ordinates indicate attempted movement outside of these coordinates then it will stop movement. This is an optional feature for the caddy.

### Vehicle Host Controller (or Caddy Host Controller System (CHC))

The vehicle host controller system is responsible for managing all aspects of the vehicle operation. It determines operation of the vehicle based on the appropriate stimuli for the vehicles mode of operation as described.

When in follow me mode, it accepts data from the location system along with status from the collision and keep out systems. It controls the operation of the drive control section so that the caddy will continuously change its position based on movement of the remote unit.

When in parking mode it controls the drive control section so that the motors and or gearboxes are in neutral mode and no brake or lock is applied.

When in parked mode, it controls the drive control section such that the motors are disabled and the gearboxes and or brakes are applied.

It manages all auxiliary functions of the caddy including the selection and indication of operational modes as well as interlocks that are interference or safety related.

It takes input from a collision detection system, collision avoidance system and or keep out systems and controls movement in accordance with prescribed parameter base data.

It controls all LED operating status indication.

It provides audible annunciation by way of Beeps for any status change

It maintains a logging process of all caddy operation and use that can be extracted for external analysis if required.

It maintains a register of allowable hours of use and will prevent commencement of operation if the hours have been exceeded

It monitors battery condition and will advise if battery health has diminished below a preset operating margin.

It has provision for data and software update via USB port.

It has provision for in vehicle updating of allowable hours such updating to be by either keypad encrypted entry triggered from the host controller serial number or by USB port with an encrypted update and destroy process.

When in Follow me Mode, the CHC will accept position and distance update data from the CLS and based on rate of change will compute the speed and steering direction to instruct the CMC (Caddy Motion Control system).

The CHC operates in a closed loop mode between the CLS data feed and the Command mode to the CMC so that it is continuously attempting to locate the Caddy at a fixed distance from the RTU based on the RSSI parameter settings.

The CHC also has maintenance mode operation whereby it can update hours, save log data, alter parameter settings and upgrade its internal firmware.

The CHC maintains a support level of utility which allows for the maintenance of usage hours along with the ability to upgrade all system firmware and operating parameters.

It maintains a log of all key operating functions and exception events and will time stamp them with date and time.

### Drive Control System (Caddy Motion Controller (CMC))

The drive control system is an integral unit that accepts commands from the host control as to required actions. It is capable of controlling two separate motors on a synchronized basis.

It is able to individually drive each motor in either forward or reverse concurrently.

It is able to be preset for rates of acceleration and deceleration and support motor braking and locking.

It is able to monitor its own operating temperature as well as motor temperature and is capable of de-rating its operation if temperature limits are reached.

Motor drive circuitry in either direction and for either motor have stall detection such that if the current to the motors increases arbitrarily then the motor drive will be terminated.

### Battery and Power Supply

The vehicle runs on a 12 Volt power source which has sufficient capacity to supply the requisite power demand of all electronics and electrical requirements of the vehicle for a full day's operation.

The battery directly feeds the drive control unit and via a separate filter all electronic assemblies within the vehicle on a distributed basis. Each electronic assembly has the requisite DC to DC converters to provide its own DC supply rails.

### Battery Charging System

The Battery charging system is separate and external to the caddy. It is connectable via an industrial grade High current DC Connector mounted on the exterior of the caddy.

All electronics within the vehicle will be turned off as a function of plugging power to the vehicle.

The battery charger system is commercially available off the shelf unit that will run from 90 to 250 VAC and will recharge a healthy battery from discharge to full in eight hours or less.

### Maintenance Control Panel (or Caddy Maintenance Control Panel(CMP))

The maintenance controller is a control panel that connects to the caddy via a flexible cable or USB port. When the CMP is connected to the caddy, the caddy recognizes that it is connected and automatically places the system in maintenance mode. The control panel provides controls for “forward and reverse” motion and “left right” steering. The system will action any commands from the panel and drive the motors at a slow fixed speed. Maintenance mode will override any setting of the caddy mode switch except parked.

The Caddy maintenance panel is a small hand held controller that connects to the Caddy via a spring coil cable and a sealed Cannon USB connector. Its function is to allow for maintenance personnel to instigate powered motion and steering to the Caddy independent of the “Follow Me system”. It has two switches that are three position spring return to Centre toggle type:

Switch 1. controls forward and reverse motion at a fixed slow speed. Position up shall cause motion forward. Switch down shall instigate motion in reverse at slow speed. Centre position is neutral.

Switch 2 controls steering. Switch left causes the vehicle to steer left when motion is active. Switch right causes the vehicle to steer right when motion is active. Switch centre position is a steer neutral position (i.e. straight ahead).

When the cable is inserted into the Caddy connection point the CHC will sense its presence and if not in Parked mode will disable selected mode of operation and only respond to control from the CMP.

All enclosures are secured from tampering and that a permanent indication that enclosures have been opened is required. All external communications are electronically password protected and connect activity logged.

The advantage of the preferred embodiment of the robotic vehicle is that it is a self-powered, self-steered vehicle (caddy) that will faithfully follow a portable receiver (RTU) at a defined distance. The vehicle will not enter zones that are preset into the system as a set of satellite navigation way points if the option is installed. Further the vehicle will stop and cease moving if contacting any solid object. The vehicle will sense impending collision with a solid object in its path and will stop prior to collision. The vehicle will observe objects that are parallel to its course and if within a distance of <200 mm will inhibit the steering such that the vehicle is not able to collide even if the RTU instructs a convergence path.

The vehicle will sense unsafe gradients and will cease following if acceptable operating limits are exceeded.

It will be able to be easily parked by Golf course personnel and will have the ability to be locked and parked so as to defeat any unauthorized usage.

Vehicle will have load sensing such that if the vehicle is overloaded it will not attempt to operate.

Vehicle will have a separate cable connected maintenance control panel to enable manual control of vehicle motion drive and steering functions.

Each unit is uniquely coded along with its remote unit such that they will only interoperate with each other.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A self-propelled robotic vehicle responsive to a radio frequency signal from a transmitter including
a vehicle frame;
at least two spaced apart receivers adapted to receive the signal from the transmitter;
a processor operatively associated with the receivers, said processor being programmed to process input from the at least two spaced apart receivers to locate the position of the transmitter and produce an electrical signal for the vehicle to move relative to the transmitter in accordance with the processor programming; and
a drive mechanism supported on the vehicle frame and adapted to receive and act on the electrical signal sent from the processor to move the vehicle in accordance with the processor programming.

2. A system for a self-propelled robotic vehicle including
a transmitter able to transmit a radio frequency signal;
a self-propelled vehicle including a vehicle frame;
at least two spaced apart receivers adapted to receive the signal from the transmitter;
a processor operatively associated with the receivers, said processor being programmed to process input from the at least two spaced apart receivers to locate the position of the transmitter and produce an electrical signal for the vehicle to move relative to the transmitter in accordance with the processor programming;
and a drive mechanism supported on the vehicle frame and adapted to receive and act on the electrical signal sent from the processor to move the vehicle in accordance with the processor programming.

3. A system as claimed in claim 2 wherein the receivers include two spaced apart antennas with each operatively linked to a respective receiver, the receiving antennas being arranged with one antenna peak tuned and the other being dip tuned so that they are 90 degrees out of phase and wherein the two signals are combined for a summed RSSI reading and measure a phase shift to determine the position of the transmitter.

4. A system as claimed in claim 2 wherein the transmitter is a transponder that sends a signal at a frequency between 200 Khz to 8 Ghertz.

5. A system as claimed in claim 2 wherein the transmitter is a transponder that sends a signal at a frequency between 300 Khz and 500 Khz.

6. A system as claimed in claim 2 wherein the transmitter is a transponder and has an antenna that can be dynamically tuned and shifted in 5 KHz increments to form 5 KHz channels.

7. A system as claimed in claim 2 wherein the transmitter is a transponder that can send out a unique signal recognized by its partnered vehicle.

8. A system as claimed in claim 2 wherein the transmitter is a transponder that can send out a unique signal recognized by its partnered vehicle, and said signal is modulated by frequency shift keying at a rate of 300 Htz or 500 Htz with +/−1 Khz frequency shift.

9. A system as claimed in claim 2 wherein the transmitter is a transponder that can send out a unique signal recognized by its partnered vehicle, and said transmissions are not synchronized to avoid a situation where multiple simultaneous transmissions are received by a receiver.

10. A system as claimed in claim 2 wherein the drive mechanism includes a front wheel which steers the vehicle in accordance with the processor programming and two rear wheels each of which are operatively connected with a motor.

11. A system as claimed in claim 2 wherein the vehicle has a collision avoidance system that has a plurality of infrared ranging transceivers spaced about the vehicle.

12. A system as claimed in claim 2 wherein the vehicle has a collision avoidance system that has a plurality of infrared ranging transceivers spaced about the vehicle, the infrared ranging transceivers including infrared charge coupled device (CCD) range sensors located about the vehicle and being capable of detecting objects up to 1.6 meters from the sensor.

13. A system as claimed in claim 2 wherein the vehicle has a collision avoidance system that has a plurality of infrared ranging transceivers spaced about the vehicle, said collision avoidance system having an outer boundary set approximately 1.2 meters from the vehicle and an inner boundary set approximately 0.3 meters for the front of the vehicle and approximately 0.08 meters for the sides of the vehicle.

14. A system as claimed in claim 2 wherein the vehicle includes a satellite navigation system to assist in controlling the movement of the vehicle in a defined area.

15. A system as claimed in claim 2 wherein the vehicle has the capability of recording the operational time of the vehicle.

16. A system as claimed in claim 2 wherein the drive mechanism includes electrical motor driven wheels and the vehicle has an override system where the electrical current powering the wheels increases up to a threshold level to keep the wheels turning, wherein when the threshold level is reached or exceeded the current to the motor is stopped.
